(19) United States
(12) Patent Application Publication
(10) Pub. No.: US 2007/0211354 A1
(43) Pub. Date: Sep. 13, 2007

(54) RETRACTABLE DOOR MIRROR

(75) Inventors: Kazunari Yamauchi, Shizuoka (JP); Kazuyoshi Umeki, Shizuoka (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Murakami Corporation, Shizuoka (JP)

(21) Appl. No.: 11/573,758

(22) PCT Filed: Oct. 1, 2004
(86) PCT No.: PCT/JP04/14514

§ 371 Date: Feb. 15, 2007

(51) Int. Cl. G02B 5/08

(52) U.S. Cl. 359/841

(57) ABSTRACT

A retractable door mirror suppressing occurrence of flutter or the like between a shaft and a shaft support in a frame, without need for strict dimensional control. In the retractable door mirror a shaft stands upright on a mirror base and a shaft support provided in a mirror body is fitted on the shaft. Notches are formed in the tip part of the shaft support and the diameter of the shaft support is slightly smaller than the diameter of the shaft. The tip part of the shaft support with the notches therein serves as an elastic portion to restrain the shaft by elastic force of the shaft support itself.

### TECHNICAL FIELD

The present invention relates to a retractable door mirror attached to a door of a car or the like for example.

### BACKGROUND ART

Door mirrors are attached to the doors of cars and many of such door mirrors are of a retractable type in recent years. A door mirror of this type has for example, a mirror base fixed to an exterior plate of a vehicle, and a mirror body attached onto this mirror base. The mirror body is retractable relative to the mirror base and is so arranged that it folds backward from a neutral position in a use state to retract a mirror and that it folds forward or backward to absorb an external force exerted on the mirror body, so as to ensure safety for pedestrians and others and prevent breakage of the door mirror.

A conventional retractable door mirror of this type is the one disclosed in Japanese Patent Publication No. 5-30994. This retractable door mirror has a stand fixed to a support arm and a rotational shaft stands upright on the stand. A shaft hole of a bracket provided in a visor is fitted onto the rotational shaft and a mirror is attached to the visor. The shaft hole of the bracket is rotatable around the rotational shaft and the shaft hole is rotated around the rotational shaft to rotate the bracket and the visor, whereby the mirror is inclinable with rotation of the visor.

Patent Document 1: Japanese Patent Publication No. 5-30994

### DISCLOSURE OF THE INVENTION

Problem to be Solved b the Invention

In the retractable door mirror disclosed in the foregoing Patent Document 1, the shaft hole of the bracket is fitted onto the rotational shaft of the stand and the mirror is inclined with rotation of the bracket around the rotational shaft. If there is a gap between the shaft hole and the rotational shaft, it will cause so-called flutter, i.e. vibration of the mirror under vibration of the vehicle or exposure to driving wind. Conversely, if the inside diameter of the shaft hole is too small with respect to the outside diameter of the rotational shaft, the shaft hole (support portion of the frame) might fail to rotate smoothly relative to the rotational shaft (shaft), so as to result in impeding the retracting motion of the mirror. Therefore, the conventional retractable door mirror had the problem that extremely strict dimensional control was required for the shaft hole and the rotational shaft.

An object of the present invention is to provide a retractable door mirror capable of suppressing occurrence of flutter or the like between a shaft and a shaft support in a frame, without need for strict dimensional control.

Means for Achieving the Object

A retractable door mirror according to the present invention, which achieves the above object, is a retractable door mirror comprising: a mirror base to be fixed to a vehicle; a shaft standing upright on the mirror base; a frame having a shaft support fitted to the shaft, and arranged to rotate around the shaft; and a mirror body attached to the frame and arranged to be retractable in a longitudinal direction of the vehicle with rotation of the frame around the shaft; wherein an elastic portion for urging the shaft support circumferentially inward of the shaft is provided at a contact part between the shaft and the shaft support in the frame.

In the retractable door mirror according to the present invention, the shaft support fitted around the shaft is provided in the frame and the elastic portion for urging the shaft support circumferentially inward of the shaft in the shaft support is provided in the contact part between the shaft and the shaft support. This elastic portion urges the shaft support against the shaft, so that the shaft support can be kept in contact with the shaft, without need for strict dimensional control. Therefore, it is feasible to suppress occurrence of flutter or the like between the shaft and the shaft support in the frame without need for strict dimensional control.

The elastic portion ca be made in such a form that a notch is formed in the contact part of the shaft support with the shaft an inside diameter of the shaft support is smaller than a outside diameter of the shaft, and the notch is broadened.

By adopting the form wherein the notch is formed in the contact part of the shaft support with the shaft, the inside diameter of the shaft support is smaller than the outside diameter of the shaft, and the notch is broadened it is feasible to readily produce the elastic portion.

It is also possible to adopt a for in which there are a plurality of notches formed and in which the plurality of notches are arranged as spaced at equal intervals in a circumferential direction of the shaft support.

When the notches are arranged as spaced at equal intervals, the urging force by the elastic portion is equally imparted, whereby the shaft support can support the shaft in a stable state.

Effect of the Invention

The retractable door mirror according to the present invention is able to suppress occurrence of flutter or the like between the shaft and the shaft support in the frame, without need for strict dimensional control.

### BRIEF DESCRIPTION OF THE DRAWINGS

FIG. 1 is a front view of a retractable door mirror according to a first embodiment.

FIG. 2 is a sectional view along line II-II in FIG. 1.

FIG. 3 is a perspective view of a state in which a shaft is inserted in a shaft support.

FIG. 4 is a perspective view showing a state in which the shaft support is expanded.

FIG. 5 is a perspective view showing a state in which the shaft support is expanded with insertion of the shaft.

FIG. 6 is a sectional side view of a retractable door mirror according to a second embodiment.

### DESCRIPTION OF REFERENCE SYMBOLS

1, 10 retractable door mirror; 2 mirror body; 3 mirror base; 3a shaft stand; 4 shaft; 5 frame; 6 shaft support; 6A notches; 7 flange; 8 spring.

### BEST MODE FOR CARRYING OUT THE INVENTION

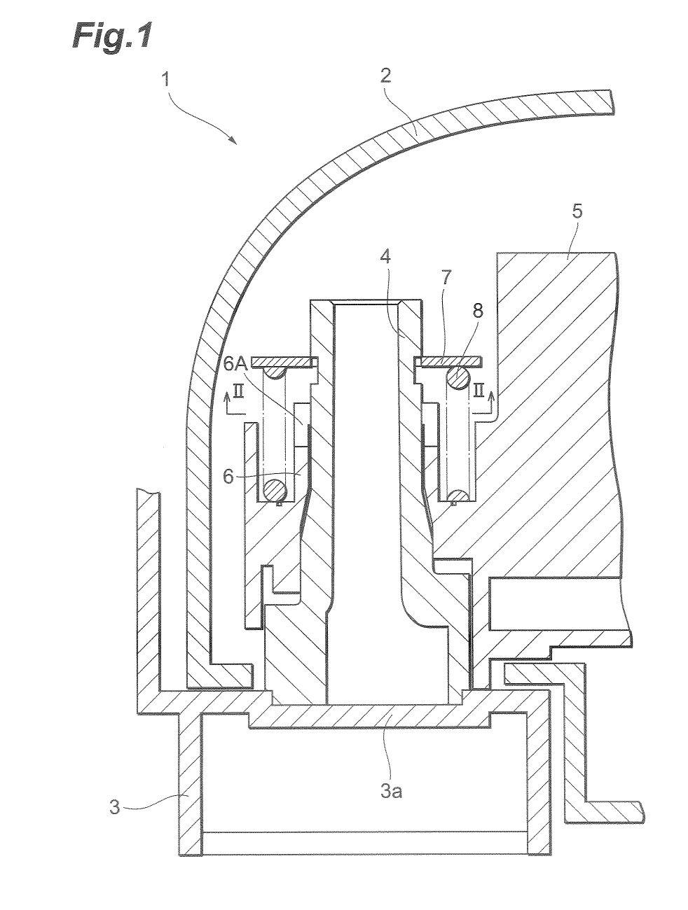

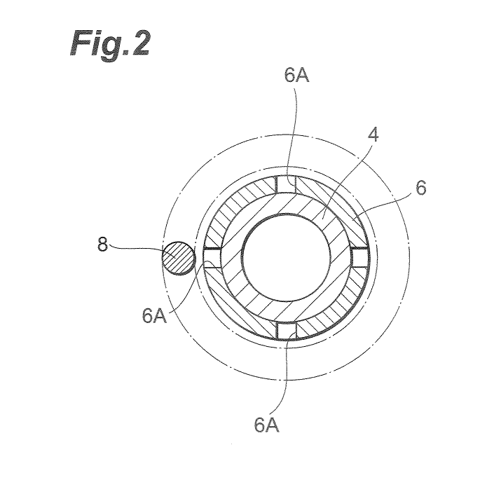

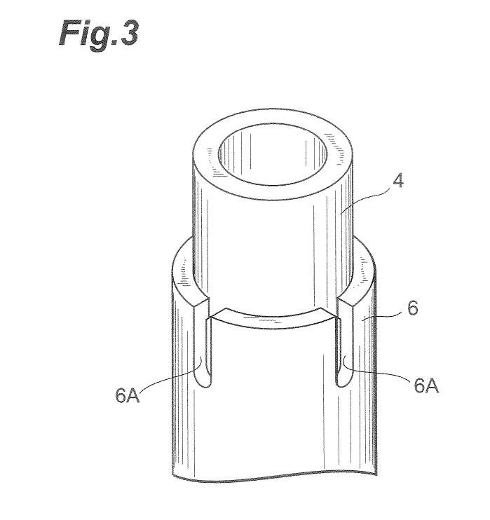

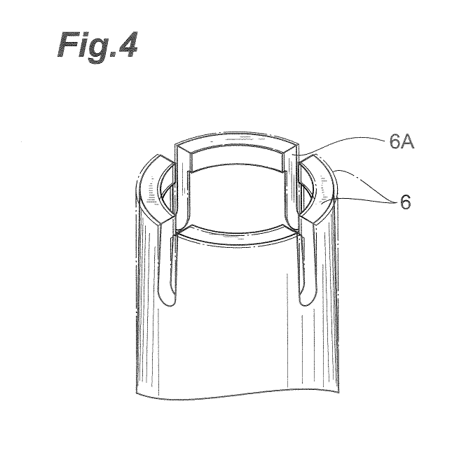

The first embodiment of the present invention will be described below with reference to the drawings FIG. 1 is a front view of a retractable door mirror according to the first embodiment of the present invention FIG. 2 a sectional view along line II-II in FIG. 1, FIG. 3 a perspective view of a state in which a shaft is inserted in a shaft support and FIG. 4 a perspective view showing a state in which the shaft support is expanded.

As shown in FIG. 1, the retractable door mirror 1 of the present embodiment is provided with a mirror body 2 The mirror body 2 is made of resin and has a main body part not shown. A mirror is attached to the front side of this main body part.

The retractable door mirror 1 has a mirror base 3 attached to a side face of a door in a vehicle. The mirror base 3 has a shaft stand 3a projecting approximately horizontally from the side face of the door part of the vehicle, and a shaft 4 stands upright on the shaft stand 3a, as shown in FIG. 2. The shaft 4 is made of resin and in a hollow cylindrical shape. This shaft 4 is housed in the mirror body 2.

Furthermore, the mirror body 2 is fitted with a frame 5. The frame 5 is made of resin, is attached to the mirror body 2 by an unrepresented locking member, and the frame 5 and mirror body 2 move integrally. A shaft support 6 is provided in the side part on the vehicle side in the frame 5.

The shaft support 6 is of an approximately cylindrical, hollow shape and is formed integrally with the main body part of the frame . Therefore, the shaft support 6 is also made of resin as the main body part of the frame 5 is The shaft 4 is inserted into the hollow part of the shaft support 6. The inside diameter of the shaft support 6 is approximately equal to the outside diameter of the shaft 4 in a state in which the shaft 4 is inserted.

In the tip part of the shaft support 6, as shown in FIG. 2, a plurality of notches 6A, four notches in the present embodiment, are formed. These notches 6A are arranged as spaced at equal intervals in the circumferential direction of the shaft support 6. Further ore, the shaft support 6 is tapered off to the tip in a state before insertion of the shaft 4.

In this state, the inside diameter of the tip part of the shaft support 6 is smaller than the outside diameter of the shaft 4. When the shaft 4 is inserted into the shaft support 6, the tip part of the shaft support 6 is broadened to allow insertion of the shaft 4 into the shaft support 6. Since the shaft support 6 is made of resin, the tip part of the shaft support 6 becomes an elastic portion with such elasticity as to return from a broadened state to a constricted state upon insertion of the shaft 4. The elastic force in this elastic portion serves as an urging force to urge the shaft support 6 circumferentially inward of the shaft 4.

Furthermore, a flange 7 is attached to an upper position of the shaft 4 and a spring 8 is interposed between the flange 7 and the frame 5. An urging force of this spring 8 urges the frame 5 against the mirror base 3.

The shaft 4 is provided with unrepresented stoppers. As the stoppers come into contact with a part of the shaft support 6, they regulate a range of rotation of the mirror body 2 relative to the mirror base 3.

Let us describe the operation and action of the retractable door mirror of the present embodiment having the above-described configuration.

The retractable door mirror 1 of the present embodiment is of a so-called manual type. The mirror body 2 in the retractable door mirror 1 is rotatable around the axis of the shaft 4 and can be located at a neutral position where the mirror is in a use state at a rear inclined position where the mirror is in a retracted state, at a front inclined position to which the mirror escapes forward when a man hits the door mirror from the back. For example, when a man pushes the mirror body 2 retracted in the rear inclined state forward, the mirror body 2 rotates to the use position.

When a man collides with the mirror body 2 in the use state, the mirror body 2 escapes forward to rotate to the front inclined position. The range of rotation to these front inclined position and rear inclined position is regulated by contact of the stopper contact part of the mirror body 2 with the stoppers.

In the retractable door mirror 1 of the present embodiment, the frame 5 is provided with the shaft support 6, and the shaft support 6 is fitted onto the shaft 4. The notches 6A are formed in the shaft support 6, and the shaft support 6 is fitted onto the shaft 4, so as to broaden the tip part of the shaft support 6.

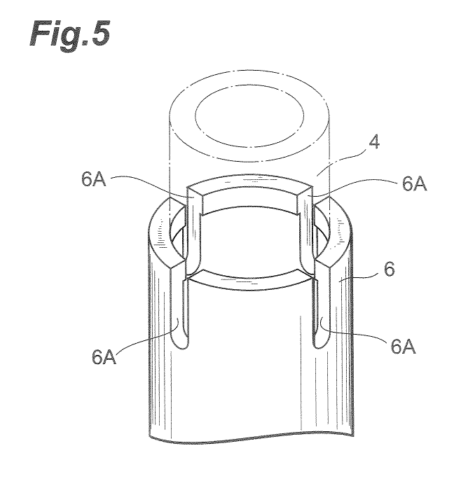

The broadened state of the shaft support 6 is indicated by imaginary lines in FIG. 4 and a state before broadened by solid lines. As shown in FIG. 4 there is only a small change between diameters of the shaft support 6 before and after broadened, and, specifically, the change is only an increase of about 2 mm in diameter. As shown in FIG. 5, the shaft support 6 in an inserted state of the shaft 4 is in the broadened state. Since the change of diameter is small between in the state before broadened and in the broadened state when the shaft 4 is inserted into the shaft support 6, the inserting work can be easily performed.

The tip part of the shaft support 6 is broadened in its diameter though the change is small For this reason, an elastic force to return to the original shape acts on the shaft support 6. This elastic force serves as a force to fasten the shaft 4, and urges the shaft support 6 against the shaft 4, therefore, the shaft support 6 can be kept in contact with the shaft 4, without need for strict dimensional control. Therefore, it is feasible to suppress occurrence of flutter or the like between the shaft 4 and the shaft support 6, without need for strict dimensional control.

Furthermore, in the retractable door mirror 1 of the present embodiment, the notches 6A are formed in the contact part of the shaft support 6 with the shaft 4 The inside diameter of the shaft support 6 is made smaller than the outside diameter of the shaft 4, and the notches 6A are broadened to provide the elastic force. For this reason, the shaft 4 can be restrained by the elastic force of the shaft support 6 itself, without need for use of any particular elasticity providing means. Therefore, since the elastic force can be provided by simply forming the notches 6A, the elasticity providing means can be readily formed and there is no increase in the number of pars in particular.

In addition, in the shaft support 6 of the present embodiment, the notches 6A are formed at four positions spaced at equal intervals in the circumferential direction of the shaft support 6. For this reason, the shaft 4 can be restrained and supported in a stable state by the shaft support 6.

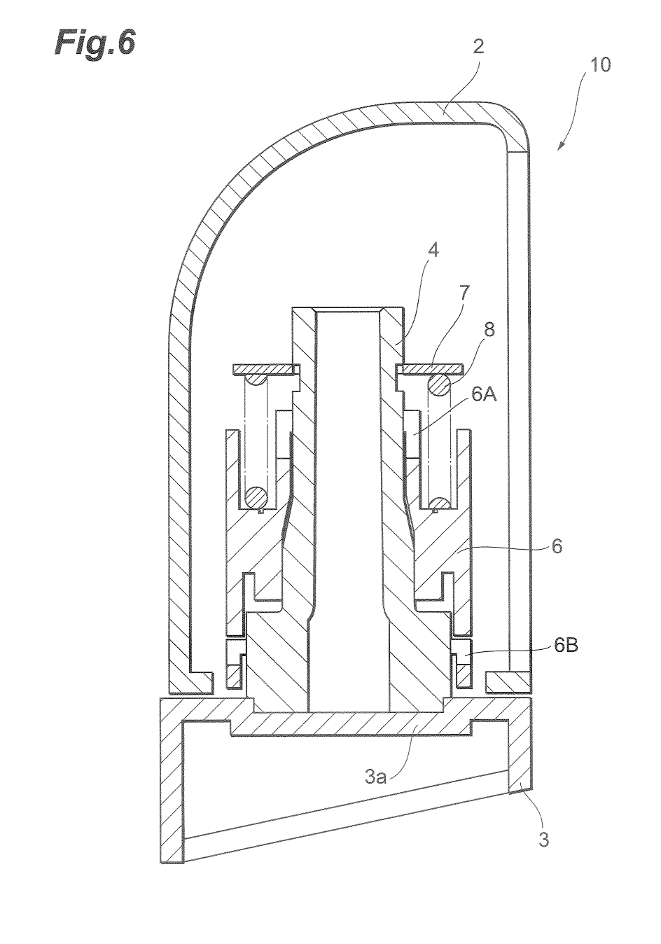

Next, the second embodiment of the present invention will be described. The retractable door mirror of the present embodiment is different from the first embodiment mainly in that second notches are formed. FIG. 6 is a sectional side view of the retractable door mirror according to the second embodiment of the present invention.

As shown in FIG. 6, the retractable door mirror 10 of the present embodiment is provided with the mirror body 2 and mirror base 3 similar to those in the aforementioned first embodiment, the shaft stand 3a is formed in the mirror base 3, and the shaft 4 stands upright on the shaft stand 3a.

The shaft support 6 in the frame 5 is attached to the shaft 4. Notches 6A similar to those in the first embodiment are formed in the tip part of the shaft support 6, and second notches 6B are formed near the base end (lower end) of the shaft 4. The second notches 6B are formed at four positions and at equal intervals in the circumferential direction of the shaft 4 as the notches 6A are. The second notches 6B are fitted in a part with a large diameter near the base end of the shaft 4. The second notches 6B also have a diameter slightly smaller than that of the shaft 4 and have elasticity as the notches 6A do.

When the shaft 4 is fitted into this shaft support 6, the shaft 4 is restrained and supported by the second notches 6B as well as the notches 6A. Therefore, the frame 5 (FIG. 1) can be attached in a firmly restrained state through the shaft support 6 to the shaft 4.

The preferred embodiments of the present invention were described above, and it is noted that the present invention is by no means limited to the above embodiments. For example, the above embodiments showed the applications to the so-called manual type door mirrors, but the present invention is also applicable to automatic door mirrors of a type in which a door mirror is rotated by a driving means such as a motor. Furthermore the above embodiments showed the formation of the elastic portion by forming the notches 6A in the tip part of the shaft support 6, but it is also possible to adopt a form in which the elastic portion is formed by a separate elastic member using a spring, rubber, or the like.

In the formation of the notches 6A, there are no particular restrictions on the number, arrangement, shape, etc. of the notches. Concerning these number arrangement, etc., the same also applies to the second notches 6B in the second embodiment. On the other hand, the aforementioned second embodiment had the form in which the second notches 6B, in addition to the notches 6A were formed but it is also possible to form the shaft restraining part with elasticity only in the part of the second notches 6B.

1. A retractable door mirror comprising:
a mirror base to be fixed to a vehicle;
a shaft standing upright on the mirror base;
a frame having a shaft support fitted to the shaft, and arranged to rotate around the shaft; and
a mirror body attached to the frame and arranged to be retractable in a longitudinal direction of the vehicle with rotation of the frame around the shaft;
wherein an elastic portion for urging the shaft support circumferentially inward of the shaft is provided at a contact part between the shaft and the shaft support in the frame.

2. The retractable door mirror according to claim 1, wherein the elastic portion is made by forming a notch in the contact part of the shaft support with the shaft, making an inside diameter of the shaft support smaller than an outside diameter of the shaft, and broadening the notch.

3. The retractable door mirror according to claim 2, which can be arranged in a form in which there are a plurality of said notches and in which the plurality of notches are arranged as spaced at equal intervals in a circumferential direction of the shaft support.
